(19) United States
(12) Patent Application Publication
(10) Pub. No.: US 2020/0048931 A1
(43) Pub. Date: Feb. 13, 2020

(54) COMBINATION LOCK

(71) Applicant: Yao-Kun Yang, CHANGHUA COUNTY (TW)

(72) Inventor: Yao-Kun Yang, CHANGHUA COUNTY (TW)

(21) Appl. No.: 16/100,208

(22) Filed: Aug. 10, 2018

(51) Int. Cl. E05B 37/00; E05B 37/02; E05B 67/22

(52) U.S. Cl. CPC E05B 37/0068; E05B 37/025; E05B 37/0044; E05B 67/22; E05B 37/0048; E05B 37/0034

(57) ABSTRACT

A combination lock includes a body with a shackle and a keybox connected thereto. A combination device IS connected to the body and includes a first control panel, a second control panel and a switch button. The first control panel includes multiple digit wheels rotatably connected thereto, and the second control panel includes multiple number buttons and multiple function buttons. The first control panel and the second control panel control the shackle and the cover of the keybox. The switch button is switched to a first position to activate the first control panel, and the switch button is switched to a second position to activate the second control panel.

### BACKGROUND OF THE INVENTION

### 1. Fields of the Invention

The present invention relates to a combination lock, and more particularly, to a combination lock with two different types of control panels so as to provide advanced security.

### 2. Descriptions of Related Art

The conventional combination lock generally includes 3 to 4 digital wheels and each wheel has 0 to 9 digits, the correct combination requires the pre-set digit shown in each of the digit wheels. Nevertheless, the shortcomings of the conventional combination locks is that the combination of the digits can be decoded, or the users forget the combination. Besides, a surf lock is developed and provides a keybox that is used to safely keep keys in the keybox. The keybox is also controlled by a correct combination.

The present invention is intended to provide a combination lock with a keybox, and the combination lock is designed to eliminate the drawbacks mentioned above.

### SUMMARY OF THE INVENTION

The present invention relates to a combination lock and comprises a body which has a shackle and a keybox. A combination device is connected to the body and has a first control panel, a second control panel and a switch button. The first control panel has multiple digit wheels rotatably connected thereto. The second control panel has multiple number buttons and multiple function buttons, wherein the number buttons include 0 to 9 respectively marked thereon. The first control panel and the second control panel control the shackle and the cover. The switch button is switched to a first position to activate the first control panel, and the switch button switched to a second position to activate the second control panel.

Preferably, the first control panels include a first combination, and the second control panel includes a second combination. When the switch button is switched to the first position, the shackle is operated by inputting the first combination from the first control panel. When the switch button is switched to the second position, the cover is opened relative to the keybox by inputting the second combination from the second control panel.

Preferably, the first control panels includes a first combination, and the second control panel includes a second combination. When the switch button is switched to the first position, the shackle is operated and the cover is opened relative to the keybox by inputting the first combination or the second combination from the first control panel. When the switch button is switched to the second position, the shackle is operated and the cover is opened relative to the keybox by inputting the first combination or the second combination from the second control panel.

Preferably, the first control panel includes a first combination and a second combination. When the switch button is switched to the first position, the shackle is operated by inputting the first combination from the first control panel. When the switch button is switched to the second position, the cover is opened relative to the keybox by inputting the second combination from the first control panel.

Preferably, the second control panel includes a first combination and a second combination. When the switch button is switched to the first position, the shackle is operated by inputting the first combination from the second control panel. When the switch button is switched to the second position, the cover is opened relative to the keybox by inputting the second combination from the second control panel.

Preferably, the first control panel includes a first combination, and the second control panel includes a second combination. A first combined combination is defined by a combination of the first combination and the second combination. The first control panel includes a third combination, and the second control panel includes a fourth combination. A second combined combination is defined by a combination of the third combination and the fourth combination. When the switch button is switched to the first position, the shackle is operated by inputting the first combined combination from the first control panel and the second control panel. When the switch button is switched to the second position, the cover is opened relative to the keybox by inputting the second combined combination from the first control panel and the second control panel.

Preferably, the second control panel is connected with an application of a smart phone. The second control panel includes a combination which is set by operating the application from the smart phone. The shackle is operated and/or the cover is opened relative to the keybox by inputting the combination from the second control panel.

Preferably, the second control panel is connected with an application of a smart phone. The second control panel includes a combination which is set by operating the application from the smart phone. The shackle is operated and/or the cover is opened relative to the keybox by inputting the combination from the smart phone.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the front view of the combination lock of the present invention, wherein the combination lock is in locked status;

FIG. 2 shows the front view of the combination lock of the present invention, wherein the combination lock is in unlocked status;

FIG. 3 shows that the cover is opened relative to the keybox of the combination lock of the present invention;

FIG. 4 shows the first control way of the combination lock of the present invention;

FIG. 5 shows the second control way of the combination lock of the present invention;

FIG. 6 shows the third control way of the combination lock of the present invention;

FIG. 7 shows the fourth control way of the combination lock of the present invention;

FIG. 8 shows the fifth control way of the combination lock of the present invention;

FIG. 9 shows the sixth control way of the combination lock of the present invention, and

FIG. 10 shows the sixth control way of the combination lock of the present invention.

### DETAILED DESCRIPTION OF THE PREFERRED EMBODIMENT

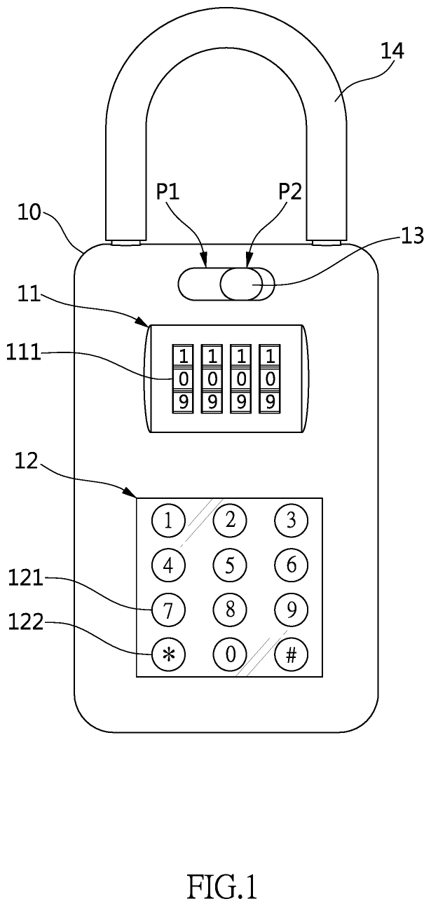

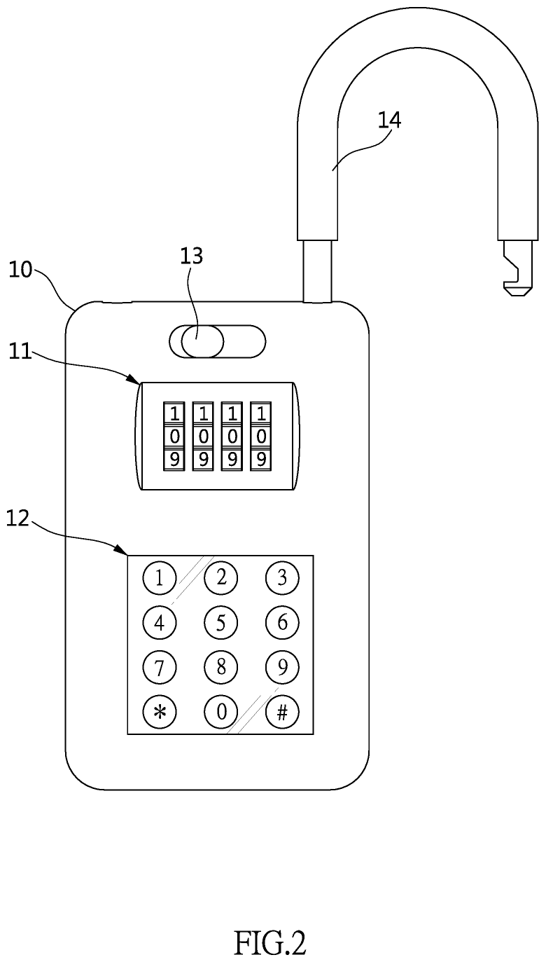

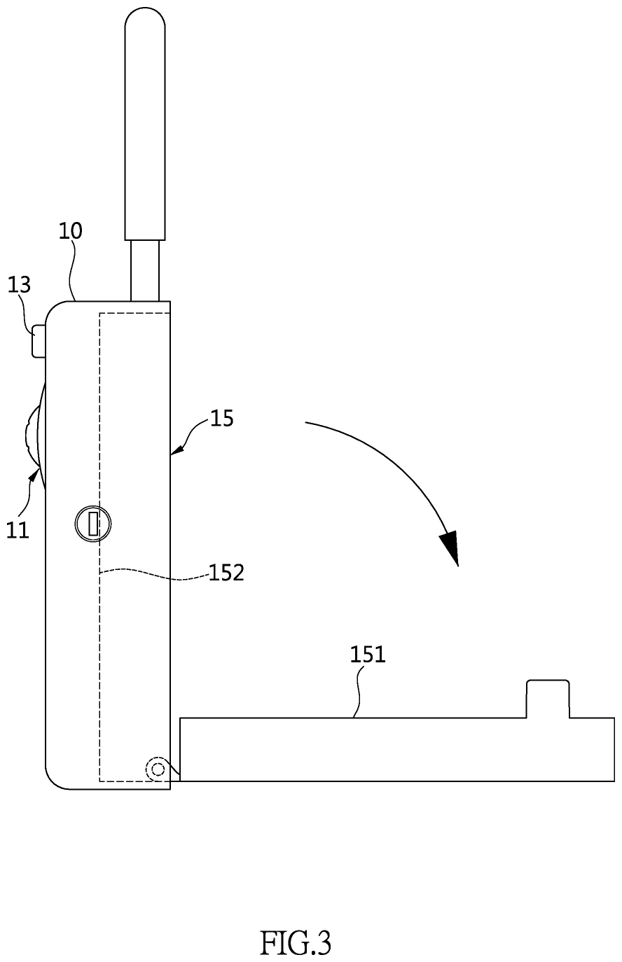

Referring to FIGS. 1 to 3, the combination lock of the present invention comprises a body 10 and a shackle 14, wherein the shackle 14 has the first end pivotably and movably connected to the body 10, and the second end of the shackle 14 is removably inserted into the body 10. A keybox 15 is located in the body 10 and includes a room 152 for receiving keys or the like therein. A cover 151 is pivotably connected to the body 10 and is able to close the room 152 for safety reason by any known methods.

The combination lock has a combination device connected to the body 10 and includes a first control panel 11, a second control panel 12 and a switch button 13. The first control panel 11 has multiple digit wheels 11 rotatably connected thereto. The second control panel 12 has multiple number buttons 121 and multiple function buttons 122. The number buttons 121 has 0 to 9 respectively marked thereon. The first control panel 11 and the second control panel 12 control the shackle 14 and the cover 151. The switch button 13 can be switched to a first position P1 to activate the first control panel 11, and the switch button 13 can be switched to a second position P2 to activate the second control panel 12.

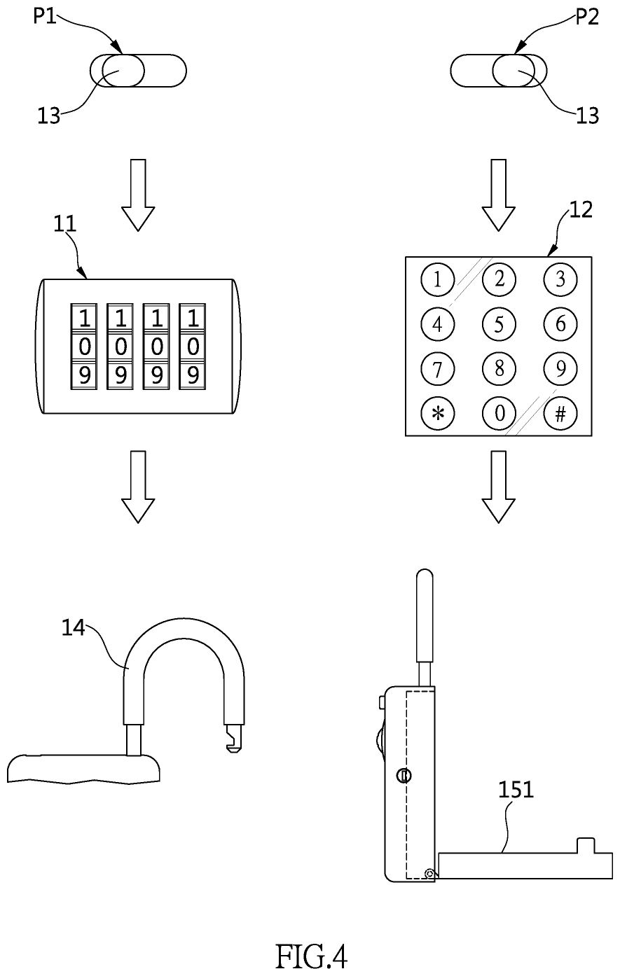

There are six ways to operate the combination lock. The first way is that the first control panels 11 includes a first combination, and the second control panel 12 includes a second combination. As shown in FIG. 4, when the switch button 13 is switched to the first position P1, the shackle 14 is operated by inputting the first combination from the first control panel 11. When the switch button 13 is switched to the second position P2, the cover 151 is opened relative to the keybox 15 by inputting the second combination from the second control panel 12. Of course, the first combination of the first control panels 11 can be set to control the cover 151, and the second combination of the second control panels 12 can be set to control the shackle 14.

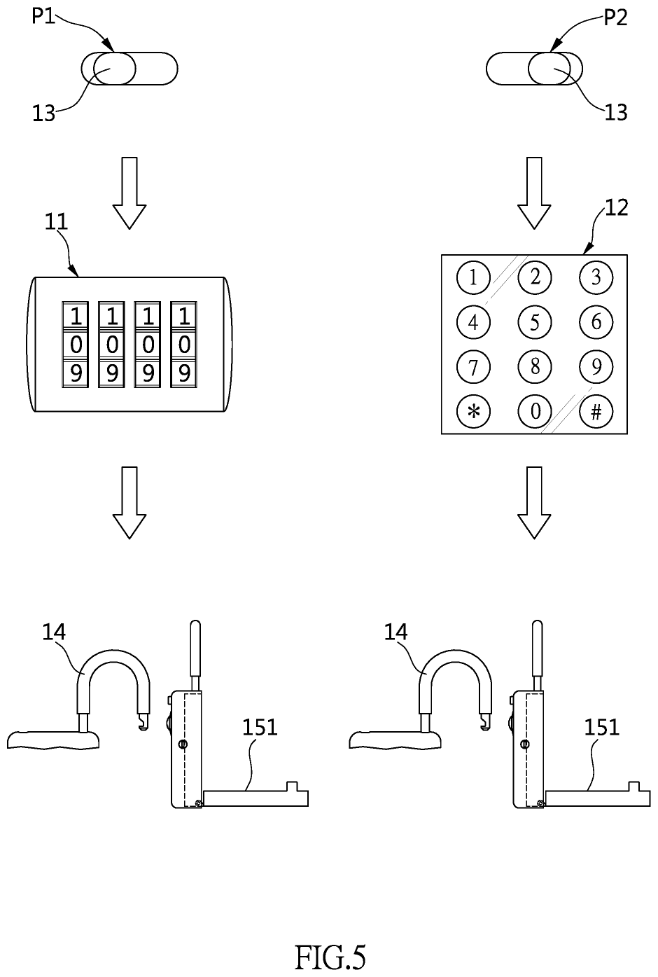

The second way is that the first control panels 11 includes a first combination, and the second control panel 12 includes a second combination. As shown in FIG. 5, when the switch button 13 is switched to the first position P1, the shackle 14 is operated and the cover 151 is opened relative to the keybox 15 by inputting the first combination or the second combination from the first control panel 11. If the first control panel 11 is out of order, the switch button 13 is switched to the second position P2, the shackle 14 is operated and the cover 151 is opened relative to the keybox 15 by inputting the first combination or the second combination from the second control panel 12. The first combination can be used as a primary combination and the second combination can be used as a secondary combination.

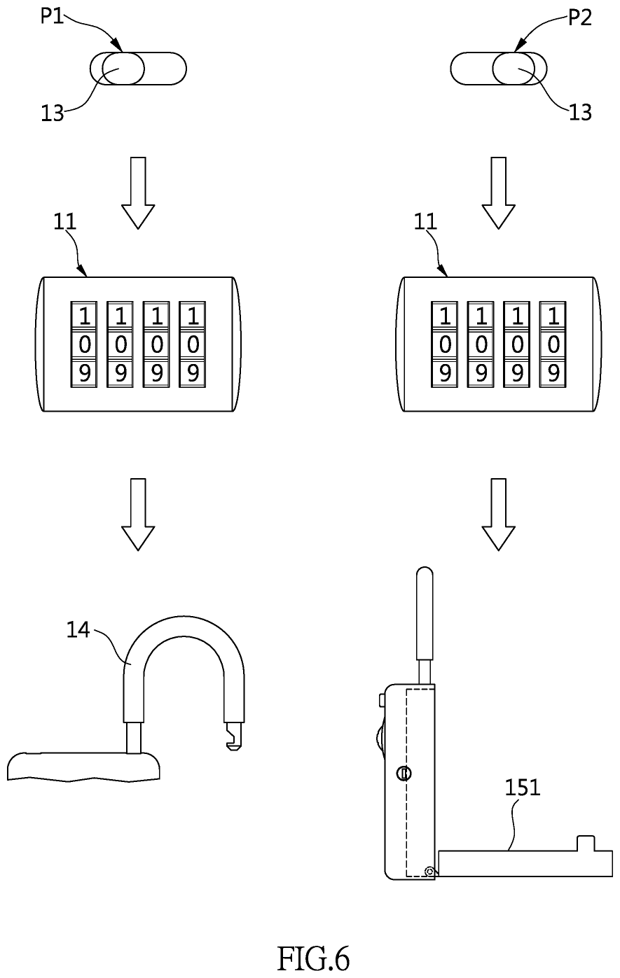

The third way is that the first control panel 11 includes a first combination and a second combination. As shown in FIG. 6, when the switch button 13 is switched to the first position P1, the shackle 14 is operated by inputting the first combination from the first control panel 11. When the switch button 13 is switched to the second position P2, the cover 151 is opened relative to the keybox 15 by inputting the second combination from the first control panel 11. Again, the first combination may be set to control the cover 151, and the second combination may be set to control the shackle 14.

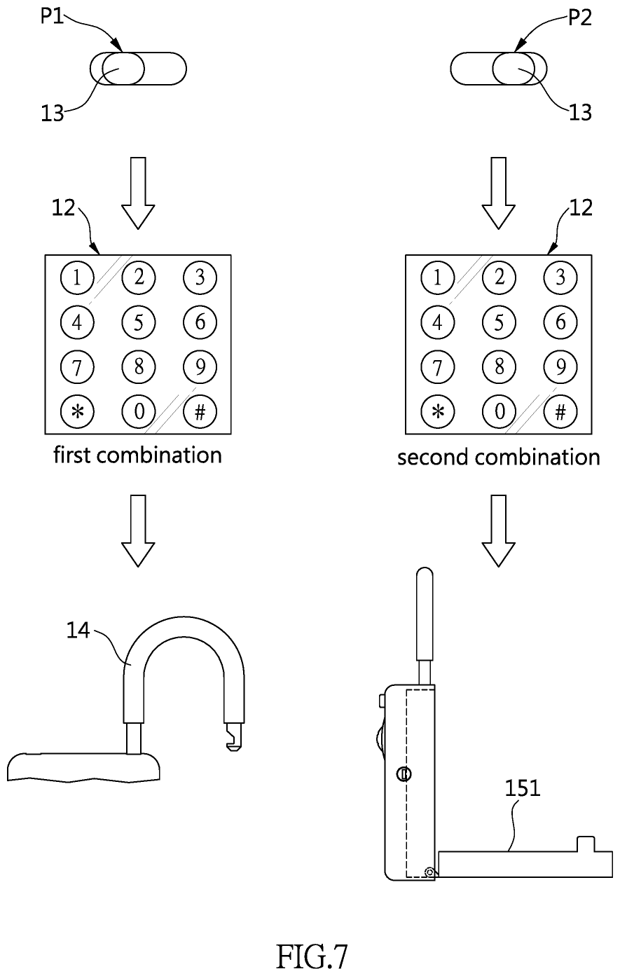

The fourth way is that the second control panel 12 includes a first combination and a second combination. As shown in FIG. 7, when the switch button 13 is switched to the first position P1, the shackle 14 is operated by inputting the first combination from the second control panel 12. When the switch button 13 is switched to the second position P2, the cover 151 is opened relative to the keybox 15 by inputting the second combination from the second control panel 12. Again, the first combination may be set to control the cover 151, and the second combination may be set to control the shackle 14.

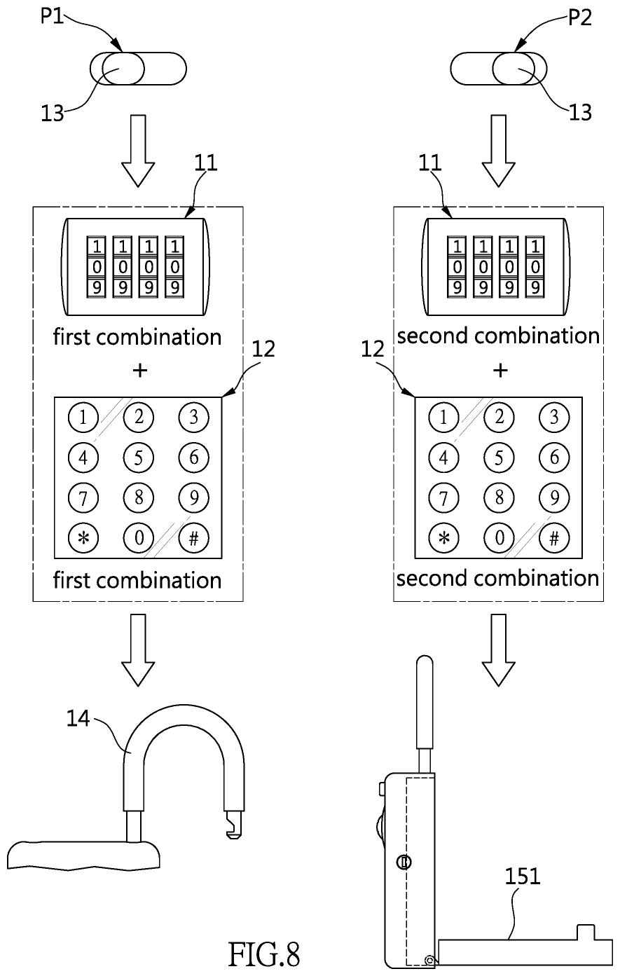

The fifth way is that, as shown in FIG. 8, the first control panel 11 includes a first combination, and the second control panel 12 includes a second combination. A first combined combination is defined by a combination of the first combination and the second combination. The first control panel 11 includes a third combination, and the second control panel 12 includes a fourth combination. A second combined combination is defined by a combination of the third combination and the fourth combination. When the switch button 13 is switched to the first position P1, the shackle 14 is operated by inputting the first combined combination from the first control panel 11 and the second control panel 12 respectively. When the switch button 13 is switched to the second position P2, the cover 151 is opened relative to the keybox 15 by inputting the second combined combination from the first control panel 11 and the second control panel 12 respectively. The first combined combination may be set to control the cover 151, and the second combined combination may be set to control the shackle 14.

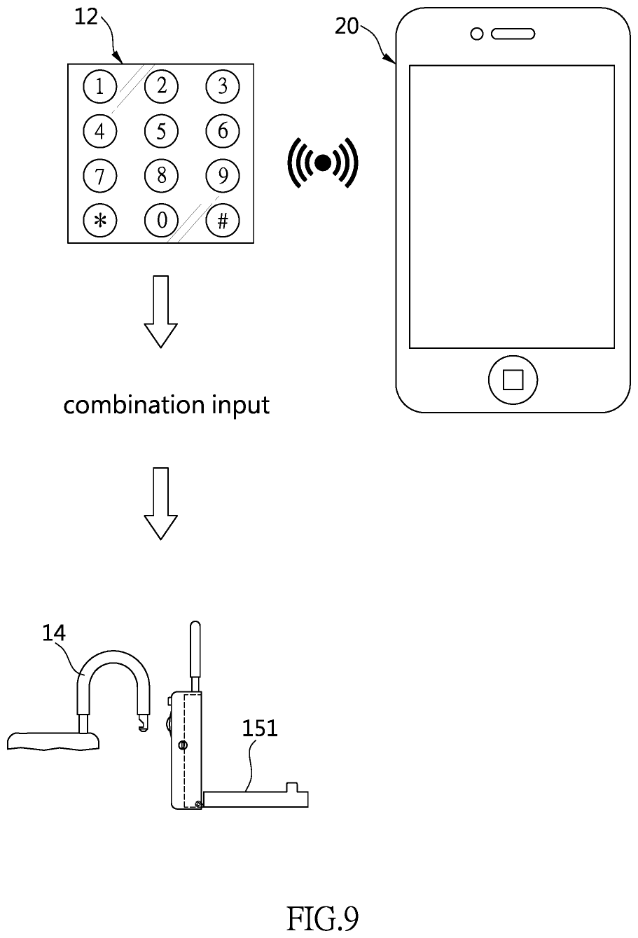

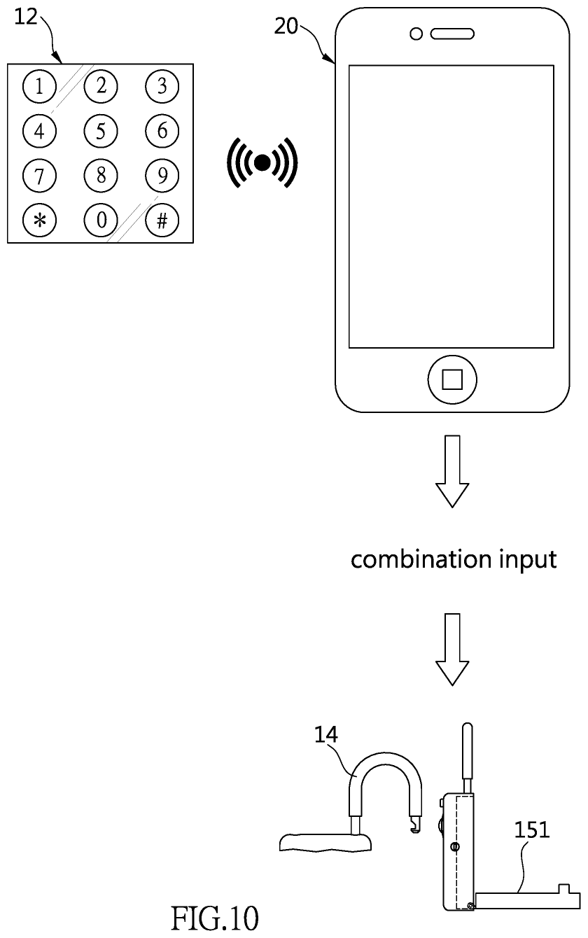

The sixth way is that, as shown in FIG. 9, the second control panel 12 is connected with an application of a smart phone. The second control panel 12 includes a combination which is set by operating the application from the smart phone. The shackle 14 is operated and/or the cover 151 is opened relative to the keybox 15 by inputting the combination from the second control panel 12. Alternatively, as shown in FIG. 10, the second control panel 12 is connected with an application of a smart phone. The second control panel 12 includes a combination which is set by operating the application from the smart phone, the shackle 14 is operated and/or the cover 151 is opened relative to the keybox 15 by inputting the combination from the smart phone. This allows the users to operate the combination lock from a remote position.

While we have shown and described the embodiment in accordance with the present invention, it should be clear to those skilled in the art that further embodiments may be made without departing from the scope of the present invention.

What is claimed is:

1. A combination lock comprising:
a body and a shackle which has a first end pivotably and movably connected to the body, a second end of the shackle is removably inserted into the body, a keybox located in the body and having a cover, and
a combination device connected to the body and having a first control panel, a second control panel and a switch button, the first control panel having multiple digit wheels rotatably connected thereto, the second control panel having multiple number buttons and multiple function buttons, the number buttons having 0 to 9 respectively marked thereon, the first control panel and the second control panel controlling the shackle and the cover, the switch button being switched to a first position to activate the first control panel, the switch button being switched to a second position to activate the second control panel.

2. The combination lock as claimed in claim 1, wherein the first control panels includes a first combination, and the second control panel includes a second combination, when the switch button is switched to the first position, the shackle is operated by inputting the first combination from the first control panel, when the switch button is switched to the second position, the cover is opened relative to the keybox by inputting the second combination from the second control panel.

3. The combination lock as claimed in claim 1, wherein the first control panels includes a first combination, and the second control panel includes a second combination, when the switch button is switched to the first position, the shackle is operated and the cover is opened relative to the keybox by inputting the first combination or the second combination from the first control panel, when the switch button is switched to the second position, the shackle is operated and the cover is opened relative to the keybox by inputting the first combination or the second combination from the second control panel.

4. The combination lock as claimed in claim 1, wherein the first control panel includes a first combination and a second combination, when the switch button is switched to the first position, the shackle is operated by inputting the first combination from the first control panel, when the switch button is switched to the second position, the cover is opened relative to the keybox by inputting the second combination from the first control panel.

5. The combination lock as claimed in claim 1, wherein the second control panel includes a first combination and a second combination, when the switch button is switched to the first position, the shackle is operated by inputting the first combination from the second control panel, when the switch button is switched to the second position, the cover is opened relative to the keybox by inputting the second combination from the second control panel.

6. The combination lock as claimed in claim 1, wherein the first control panel includes a first combination, and the second control panel includes a second combination, a first combined combination is defined by a combination of the first combination and the second combination, the first control panel includes a third combination, and the second control panel includes a fourth combination, a second combined combination is defined by a combination of the third combination and the fourth combination, when the switch button is switched to the first position, the shackle is operated by inputting the first combined combination from the first control panel and the second control panel, when the switch button is switched to the second position, the cover is opened relative to the keybox by inputting the second combined combination from the first control panel and the second control panel.

7. The combination lock as claimed in claim 1, wherein the second control panel is connected with an application of a smart phone, the second control panel includes a combination which is set by operating the application from the smart phone, the shackle is operated and/or the cover is opened relative to the keybox by inputting the combination from the second control panel.

8. The combination lock as claimed in claim 1, wherein the second control panel is connected with an application of a smart phone, the second control panel includes a combination which is set by operating the application from the smart phone, the shackle is operated and/or the cover is opened relative to the keybox by inputting the combination from the smart phone.
